(19) United States
(12) Patent Application Publication
(10) Pub. No.: US 2007/0208379 A1
(43) Pub. Date: Sep. 6, 2007

(54) Kessler project

(76) Inventors: Raymond Kessler, Upper Darby, PA (US); Christina Kessler, Upper Darby, PA (US)

Correspondence Address: Raymond M. Galasso;Galasso & Associates LP, P.O. Box 26503, Austin, TX, 78755-0503, US

(21) Appl. No.: 11/712,860

(22) Filed: Mar. 1, 2007

Related U.S. Application Data
(60) Provisional application No. 60/779,187, filed on Mar. 3, 2006.

(51) Int. Cl. A61J 17/00

(52) U.S. Cl. 606/234

(57) ABSTRACT

Kessler Project is a pacifier that can be filled with distilled water or the like and then be refrigerated or frozen. The preferred embodiment of the invention utilizes a mouth guard, a nipple, a ring, a cap, and a base. To use the preferred embodiment of Kessler Project, an individual would remove the cap on the base and fill the nipple and base of the device with water. The cap would then snap onto the base of the device, allowing the user to place the device into a refrigerator or freezer to cool. Once the appropriate water temperature is reached, the device is removed from the refrigerator or freezer and given to the infant. The ring of the device is dimensioned to be easy for an infant to grasp to allow him to place the nipple into his mouth. The mouth guard prevents the device from being swallowed when the nipple is inserted into the baby's mouth. The design of the device allows the baby to place the nipple in his mouth without having to constantly hold the cold ring of the device.

### CROSS REFERENCE TO RELATED APPLICATIONS

This United States Non-Provisional Patent Application claims priority to U.S. Provisional Patent Application No. 60/779,187 entitled “Kessler Project” filed Mar. 3, 2006.

### FIELD OF THE DISCLOSURE

The disclosures made herein relate generally to the baby accessories industry. The invention discussed herein is in the general classification of teething rings and pacifiers.

### BACKGROUND

Teething refers to the eruption of a child's first set of teeth often causing sore gums. Teething is a normal part of child development. The first teeth usually start to come in when the baby reaches about six to twelve months old. Two bottom front teeth usually poke through first, followed quite quickly by several more. Teething lasts from six months to three years.

Teething babies usually like chewing on a cool teething ring or wet washcloth. A traditional teething ring is made of firm rubber and consists of only one piece. Many teething rings are large, heavy and cold, making them difficult for babies to hold comfortably. Washcloths or the like are also difficult for a baby to grasp and need to constantly be cooled to provide soothing comfort for the infant.

Hence, there is a need in the art for a convenient to use, inexpensive, durable, safe, appropriately sized, non-handheld and effective device for comforting a baby during teething.

### SUMMARY OF THE DISCLOSURE

Kessler Project is a pacifier that can be filled with distilled water or the like and then be refrigerated or frozen.

The preferred embodiment of the invention utilizes a mouth guard, a nipple, a ring, a cap, and a base.

Certain embodiments of the invention may incorporate different style and shape mouth guards, caps, bases, and rings. Other embodiments may come with stands for holding the device in the refrigerator or freezer and storage bags for maintaining the temperature of the device.

The principal object of this invention is to provide a device with a nipple capable of holding fluid used to soothe a baby during teething.

Another object of this invention is to provide a device to cool a baby's mouth and gums during teething.

Another object of this invention is to provide a device that will not need to be held by a baby to soothe him during teething.

Another object of this invention is to provide an affordable device for soothing a baby during teething.

Another object of this invention is to provide a light-weight device for soothing a baby during teething.

Another object of this invention is to provide a safe device for soothing a baby during teething.

Yet another object of this invention is to provide a durable device for soothing a baby during teething.

### BRIEF DESCRIPTION OF THE DRAWINGS

FIG. 1 depicts a perspective view of the preferred embodiment of the invention with the cap removed.

FIG. 2 depicts a rear view of the preferred embodiment of the invention with the cap attached.

FIG. 3 depicts a cross-sectional view of the preferred embodiment of the invention cut along the line A-A of FIG. 1.

### DETAILED DESCRIPTION OF THE DRAWINGS

The preferred embodiment of Kessler Project is comprised of at least some of the following: a mouth guard, a nipple, a ring, a cap, and a base.

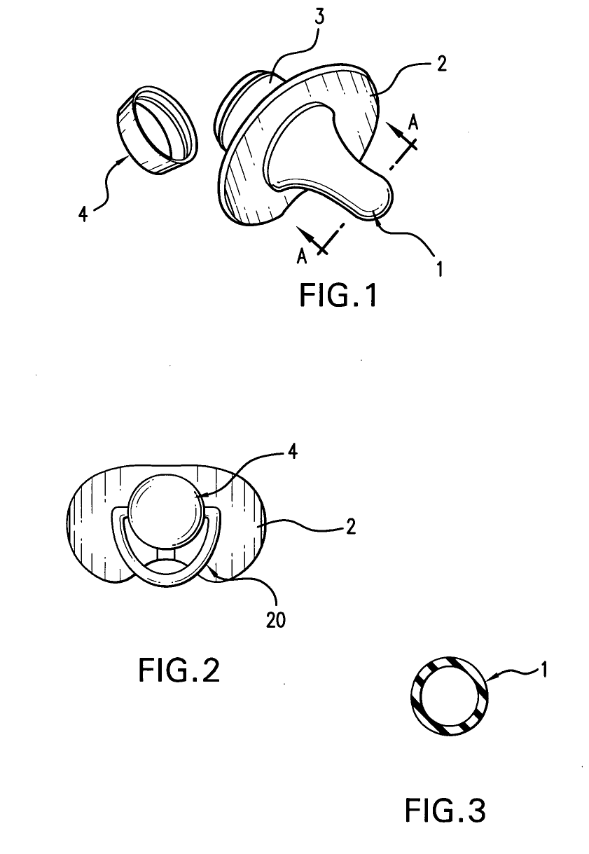

FIG. 1 depicts a perspective view of the preferred embodiment of the invention with the cap removed. A nipple 1 is attached to a mouth guard 2. The nipple 1 is dimensioned to standard pacifier sizes to allow it easily to be inserted into a baby's mouth. The nipple 1 is made of silicon in this preferred embodiment though a variety of other materials such as rubber are also possible. The nipple 1 is capable of holding a fluid such as water. The mouth guard 2 is made of plastic in this preferred embodiment and has an approximately oval design.

A base 3 is located on the opposite side of the mouth guard 2 from the nipple 1. The base 3 is cylindrical in this preferred embodiment and is made of plastic. The base 3 is one inch long and has a diameter of one inch in this preferred embodiment though a variety of sizes are possible. A cap 4 is dimensioned to snap onto the base 3 in this preferred embodiment though a variety of attaching mechanisms to the base are possible, including a threaded screw-on design. The cap 4 is also cylindrical and made of plastic, having a length of approximately half an inch and a diameter of approximately one inch. The base 3 connects through the mouth guard 2 to the nipple 1 to allow the nipple 1 and the base 3 to be filled with a fluid.

A small hole in approximately the center of the tip of the nipple could also be added to this embodiment, if desired. This hole would allow the baby to slowly consume the fluid inside the nipple while the fluid stored in the base could then move into the nipple as needed.

FIG. 2 depicts a rear view of the preferred embodiment of the invention with the cap attached. The mouth guard 2, and cap 4 are visible from this view. In addition, a ring 20 is also shown attached to the base. The ring 20 is attached in a pivoting manner on opposite sides of the base to allow rotation. The ring 20 is made of plastic and has a D-shape in this preferred embodiment though a variety of materials and shapes could be utilized.

FIG. 3 depicts a cross-sectional view of the preferred embodiment of the invention cut along the line A-A of FIG. 1. The thickness of the preferred embodiment of the nipple 1 is depicted though a wide range of thickness is possible.

Other embodiments of the device may not have the base and snap on cap. Instead, a small hole in the tip of the nipple will allow the user to fill the nipple by squeezing and submerging the nipple in a fluid. The mouth guard will provide a backing to the nipple in this particular embodiment to prevent escape of the fluid. A ring can be attached directly to the back of the mouth guard in this embodiment.

Other designs could utilize crew-on nipples that can be removed and filled with water or flip-top lids on the back of the mouth guard that can be opened, giving access to the nipple for filling with fluids.

Certain accessories would also be sold with the device, including a stand and storage bag. The stand would have pegs emanating from it to suspend the rings of the device from while the storage bags would be insulated to keep the device cool for longer periods of time during travel.

To use the preferred embodiment of Kessler Project, an individual would remove the cap on the base and fill the nipple and base of the device with water. The cap would then snap onto the base of the device, allowing the user to place the device into a refrigerator or freezer to cool. Once the appropriate water temperature is reached, the device is removed from the refrigerator or freezer and given to the infant. The ring of the device is dimensioned to be easy for an infant to grasp to allow him to place the nipple into his mouth. The mouth guard prevents the device from being swallowed when the nipple is inserted into the baby's mouth. The design of the device allows the baby to place the nipple in his mouth without having to constantly hold the cold ring of the device.

The materials utilized for Kessler Project, may vary widely but will likely include plastic and rubber components.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Kessler Project can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the components of the present invention can be of various shapes and sizes. It should also be obvious that the components of the invention can be made of different types of plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A pacifier and teething device comprising:
(a) a nipple capable of storing a fluid; and
(b) a mouth guard attached to the nipple.

2. The device of claim 1 wherein the nipple is made of silicon.

3. The device of claim 1 wherein the nipple is made of rubber.

4. The device of claim 1 wherein the mouth guard is made of plastic.

5. The device of claim 1 wherein the mouth guard is approximately oval.

6. The device of claim 1 further comprising
a base attached to the mouth guard opposite the nipple.

7. The device of claim 6 wherein the base is cylindrical.

8. The device of claim 6 wherein the base is made of plastic.

9. The device of claim 7 wherein the base is one inch long and has a diameter of one inch

10. The device of claim 6 further comprising
a cap dimensioned to snap onto the base.

11. The device of claim 6 further comprising
a cap dimensioned to screw onto the base.

12. The device of claim 10 wherein the cap is cylindrical and made of plastic.

13. The device of claim 6 further comprising
a ring attached to the base in a pivoting manner.

14. The device of claim 13 wherein the ring is made of plastic.

15. The device of claim 13 wherein the ring has a D-shape.

16. The device of claim 1 further comprising
a small hole in the nipple.

17. The device of claim 1 wherein the nipple is removable from the mouth guard.

18. The device of claim 1 further comprising
a lid on the back of the mouth guard.

19. The device of claim 18 wherein the lid is hinged to the mouth guard.

20. A pacifier and teething device comprising:
(a) a nipple attached to a mouth guard;
(b) a base attached to the mouth guard opposite the nipple;
(c) a cap attachable to the base;
(d) a ring attached in a pivoting manner to the base; and
(e) a hole located in the nipple.
